(19) United States
(12) Patent Application Publication
(10) Pub. No.: US 2009/0046387 A1
(43) Pub. Date: Feb. 19, 2009

(54) Patterned media with low switching filled and adjacent track encroachment (ATE) using ECC (exchange coupled composite) media

(75) Inventors: Sooyoul Hong, Santa Clara, CA (US); Carl (Xiao) Che, Saratoga, CA (US); Kiseok Moon, Pleasanton, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/891,995

(22) Filed: Aug. 13, 2007

(51) Int. Cl. G11B 21/02

(52) U.S. Cl. 360/77.13

(57) ABSTRACT

A patterned disk for a hard disk drive. The patterned disk includes a hard magnetic layer over a substrate. The disk further includes an exchange control layer adjacent to the hard magnetic layer and a soft magnetic layer adjacent to the exchange control layer. The hard and soft magnetic layers are arranged into a plurality of dots that are separated by a non-magnetic material. The soft and hard magnetic layers combined with the exchange control layer creates an exchange coupled composite that has a relatively low switching field and favorable thermal stability. The low switching field improves reliability when the disk is used in perpendicular recording.

### BACKGROUND OF THE INVENTION

1. Field of the Invention

The subject matter disclosed generally relates to disk media of hard disk drives.

2. Background Information

Hard disk drives contain a plurality of heads that are magnetically coupled to rotating disks. The heads write and read information by magnetizing and sensing the magnetic fields of the disk surfaces.

There are generally two different types of magnetic heads, horizontal recording heads and perpendicular recording heads (“PMR heads”). Horizontal recording heads magnetize the disk in a direction that is essentially parallel with the outer surface of the disk. PMR heads magnetize the disk in a direction essentially perpendicular to the outer surface of the disk. PMR heads are preferred because perpendicular recording allows for higher bit densities and corresponding increases in the data capacity of the drive.

The areal density of perpendicular recording is limited by magnetic cross-talk between adjacent areas of the disks. One approach to limiting cross-talk is to create a disk composed of a plurality of magnetic dots that are separated by non-magnetic material. The non-magnetic material inhibits magnetic cross-talk between the magnetic dots. Such disks are commonly referred to as bit patterned media.

When writing on a bit patterned media the recording head must switch polarity while the write element of the head is adjacent to the magnetic dot. If the polarity is not switch during a critical window the dot is not re-magnetized and data is not properly written to disk. Consequently, bit patterned media have stringent writing requirements.

### BRIEF SUMMARY OF THE INVENTION

A patterned disk for a hard disk drive. The patterned disk includes a hard magnetic layer over a substrate. The disk further includes an exchange control layer adjacent to the hard magnetic layer and a soft magnetic layer adjacent to the exchange control layer. The hard and soft magnetic layers are arranged into a plurality of dots that are separated by a non-magnetic material.

### BRIEF DESCRIPTION OF THE DRAWINGS

FIG. 1 is a top view of a hard disk drive;

FIG. 2 is an illustration of a disk of the hard disk drive;

FIG. 3 is an enlarged view of a magnetic layer of the disk;

FIG. 4 is an enlarged top view of the disk showing a plurality of magnetic dots.

### DETAILED DESCRIPTION

Disclosed is a patterned disk for a hard disk drive. The patterned disk includes a hard magnetic layer over a substrate. The disk further includes an exchange control layer adjacent to the hard magnetic layer and a soft magnetic layer adjacent to the exchange control layer. The hard and soft magnetic layers are arranged into a plurality of dots that are separated by a non-magnetic material. The soft and hard magnetic layers combined with the exchange control layer creates an exchange coupled composite that has a relatively low switching field and favorable thermal stability. The low switching field improves reliability when the disk is a bit pattern media used in perpendicular recording.

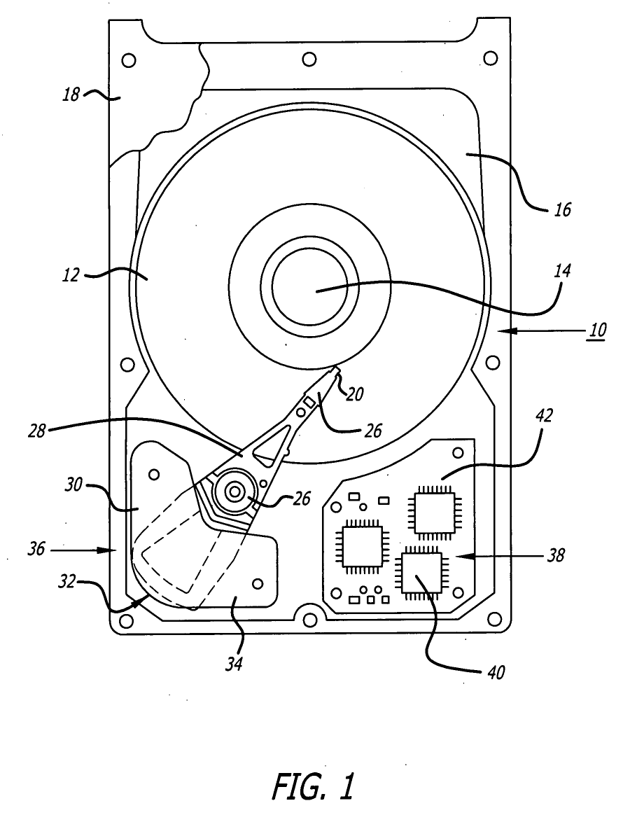

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

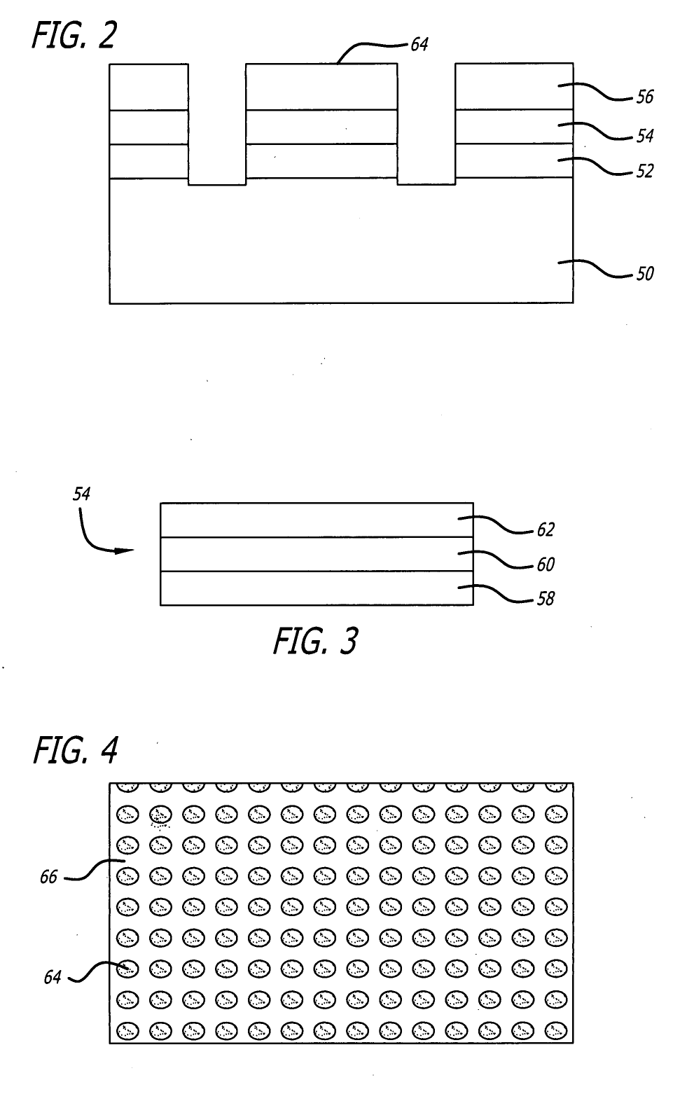

FIG. 2 shows an embodiment of the disk 12. The disk 12 includes a substrate 50 that supports an underlayer 52. The underlayer 52 may include an adhesion layer, an AFC layer, a blocking layer and an intermediate layer as is known in the art. The disk 12 includes a magnetic layer 54 and a protective layer 56.

As shown in FIG. 3, the magnetic layer 54 may include a hard magnetic layer 58, an exchange control layer 60 and a soft magnetic layer 62. The combination of layers 58, 60 and 62 create a magnetic layer that has a relatively low switching field and high thermal reliability. When used with a perpendicular recording head the low switching field increases the switching window in which the head can re-magnetize the disk. This relaxes the timing requirements of writing data onto the disk.

As shown in FIG. 4, the magnetic layer 54 is arranged into a plurality of dots 64 that are separated by non-magnetic material 66 such as air. The non-magnetic material inhibits magnetic cross-talk between the magnetic dots 64.

The protective layer 56 may include a hard diamond-like carbon material and an outer layer of lubricant as is known in the art.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A patterned magnetic disk for a hard disk drive, comprising:
a substrate;
a hard magnetic layer over said substrate;
an exchange control layer adjacent to said hard magnetic layer;
a soft magnetic layer adjacent to said exchange control layer, said hard, exchange control and soft layers being arranged into a plurality of dots; and,
a non-magnetic material that separates said dots.

2. The disk of claim 1, further comprising an adhesion layer between said substrate and said hard magnetic layer.

3. The disk of claim 1, further comprising a protective layer over said soft magnetic layer.

4. A hard disk drive, comprising:
a base plate;
a spindle motor coupled to said base plate;
a disk coupled to said spindle motor, said disk including;
a substrate;
a hard magnetic layer over said substrate;
an exchange control layer adjacent to said hard magnetic layer;
a soft magnetic layer adjacent to said exchange control layer, said hard, exchange control and soft layers being arranged into a plurality of dots;
a non-magnetic material that separates said dots;
an actuator arm mounted to said base plate;
a voice coil motor coupled to said actuator arm; and,
a head coupled to said actuator arm and said disk.

5. The disk drive of claim 4, further comprising an adhesion layer between said substrate and said hard magnetic layer.

6. The disk drive of claim 4, further comprising a protective layer over said soft magnetic layer.

7. The disk drive of claim 4, wherein said head is a perpendicular recording head.

8. A method for fabricating a disk of a hard disk drive, comprising:
forming a hard layer of magnetic material over a substrate;
forming a control exchange layer adjacent to the hard layer of magnetic material;
forming a soft layer of magnetic material adjacent to the control exchange layer, the hard, control exchange and soft layers being formed in a pattern that creates a plurality of dots; and,
applying a non-magnetic material that separates the dots.

9. The method of claim 8, further comprising applying an adhesive layer between the substrate and the soft magnetic layer.

10. The method of claim 8, further comprising applying a protective layer over the soft magnetic layer.
